(19) United States
(12) Patent Application Publication
(10) Pub. No.: US 2025/0100457 A1
(43) Pub. Date: Mar. 27, 2025

(54) TRUCK BED RACK SYSTEM

(71) Applicant: Dometic Sweden AB, Solna (SE)

(72) Inventors: Robert Herald Wissiak, Oak Park, CA (US); Stanley Illman, Santon (ZA)

(21) Appl. No.: 18/888,784

(22) Filed: Sep. 18, 2024

Related U.S. Application Data
(60) Provisional application No. 63/584,615, filed on Sep. 22, 2023.

(51) Int. Cl. B60R 9/06

(52) U.S. Cl. CPC B60R 9/065

(57) ABSTRACT

Present embodiments relate to a truck bed rack system. More particularly, but without limitation, present embodiments relate to a truck bed rack system for mounting of storage containers, accessories and the like. The truck bed rack system comprises a framework and an adjustable mounting bar which allows for positioning of brackets in different positions to compensate for different size containers and differing locations relative to the adjustable mounting bar.

### INCORPORATION BY REFERENCE

Any and all applications for which a foreign or domestic priority claim is identified in the Application Data Sheet as filed with the present application are hereby incorporated by reference herein and made a part of the present disclosure.

### BACKGROUND

### 1. Field of the Invention

Present embodiments relate to a truck bed rack system. More particularly, but without limitation, present embodiments relate to a truck bed rack system for mounting of storage containers, accessories, and the like.

### 2. Description of the Related Art

Truck bed racks are sometimes used increase storage capability if desired. Some of these truck bed racks are short height or low elevation truck bed racks as tent structures are sometimes mounted on top of the rack. While these provide additional storage capability and retention of goods, some of these devices have a lower height which may limit use of the bed more than desirable. In other words, taller objects that might otherwise fit in the truck bed may not fit with the low elevation truck bed rack in position. Additionally, truck bed racks of short height may not allow for use of containers.

The information included in this Background section of the specification, including any references cited herein and any description or discussion thereof, is included for technical reference purposes only and is not to be regarded subject matter by which the scope of the invention is to be bound.

### SUMMARY

The present application discloses one or more of the features recited in the appended claims and/or the following features which alone or in any combination, may comprise patentable subject matter.

The present embodiments provide a rack system for a truck bed is provided which allows for mounting of containers and accessories. The rack system comprises a framework of supports which are mountable to a truck and disposed about the truck bed. One or more containers and/or accessories may be supported by the framework.

According to some embodiments, a truck bed rack system comprises a first support configured to be mounted along one side of a truck bed, a second support configured to be mounted along the one side of the truck bed and spaced from the first support, a third support configured to be mounted along a second side of the truck bed, and, a fourth support configured to be mounted along the second side of the truck bed. A first cross-member extending between the first support and the third support. A second cross-member extending between the second support and the fourth support. A first bar mount extends from one of the supports, and a second bar mount extends from a second of the supports. An adjustable mounting bar extending between the first bar mount and the second bar mount. A first container guide is connected to the adjustable mounting bar and a second container guide connected to the adjustable mounting bar. The second container guide is spaced from the first container guide and configured to receive a storage container. The first container guide and the second container guide define a width limit for the storage container, and the adjustable mounting bar defines a rear positioning limit for the storage container.

In some aspects, the truck bed rack system may further comprise a first stiffener extending between the first support and the first bar mount.

In some aspects, the truck bed rack system may further comprise a second stiffener extending between the second support and the second bar mount.

In some aspects, each of the first bar mount and the second bar mount may be generally triangular in shape.

In some aspects, the first stiffener being disposed on one side of the first support and the first bar mount disposed on an opposite side of the first support.

In some aspects, the first stiffener and the first bar mount may be connected at ends spaced from the first support.

In some aspects, the second stiffener may be disposed on one side of the second support and the second bar mount disposed on an opposite side of the second support.

In some aspects, the second stiffener and the second bar mount may be connected at ends spaced from the second support.

In some aspects, the truck bed rack system may further comprise a first storage clamp and a second storage clamp retaining the storage container.

In some aspects, the first storage clamp and the second storage clamp may be attached to the first container guide and the second container guide, respectively.

In some aspects, the first storage clamp and the second storage clamp may be connected to the container and the first container guide and the second container guide.

In some aspects, the first support and the second support may be angled relative to a vertical reference.

In some aspects, the storage container may be mounted in an angled configuration so that a lid of the storage container is either aligned or is parallel with a plane extending between the first and second supports.

In some aspects, the truck bed rack system may further comprise one or more holes or grooves positioned axially along the adjustable mounting bar and configured to receive fasteners.

In some aspects, the truck bed rack system may further comprise one or more fastening locations at ends of the adjustable mounting bar.

In some aspects, the truck bed rack system may be secured either to factory fixing points in a truck bed or factory rails of the truck bed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. All of the above outlined features are to be understood as exemplary only and many more features and objectives of the various embodiments may be gleaned from the disclosure herein. Therefore, no limiting interpretation of this summary is to be understood without further reading of the entire specification, claims and drawings, included herewith. A more extensive presentation of features, details, utilities, and advantages of the present invention is provided in the following written description of various embodiments of the invention, illustrated in the accompanying drawings, and defined in the appended claims.

### BRIEF DESCRIPTION OF THE DRAWINGS

In order that the embodiments may be better understood, embodiments of a truck bed rack system will now be described by way of examples. These embodiments are not to limit the scope of the claims as other embodiments of a truck bed rack system will become apparent to one having ordinary skill in the art upon reading the instant description. Non-limiting examples of the present embodiments are shown in figures wherein:

FIG. 1 is a perspective view of a truck with a rack system mounted to the truck bed;

FIG. 2 is a perspective view of the assembled rack system removed from the truck;

FIG. 3 is a second perspective view of the assembled rack system of FIG. 2;

FIG. 4 is a partially exploded perspective view of the rack system with the containers exploded from the framework;

FIG. 5 is a second partially exploded perspective view of the rack system with the containers exploded from the framework;

FIG. 6 is a partially exploded perspective view in which the retaining components for the container are exploded from the framework;

FIG. 7 is a perspective view of the adjustable mounting bar;

FIG. 8 is a perspective view of a bar mount or bracket for mounting the adjustable mounting bar;

FIG. 9 is a perspective view of the guide bracket;

FIG. 10 is a perspective view of a clamp; and,

FIG. 11 is a perspective view depicting the interaction between the adjustable mounting bar, guide bracket, the clamp, and the container.

### DETAILED DESCRIPTION

It is to be understood that a rack system for a truck bed rack is not limited in its application to the details of construction and the arrangement of components set forth in the following description or illustrated in the drawings. The described embodiments are capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Certain terminology may be used in the following description for the purpose of reference only, and thus are not intended to be limiting. For example, terms such as “above” and “below” refer to directions in the drawings to which reference is made. Terms such as “front,” “back,” “left,” “right,” “rear,” and “side” describe the orientation and/or location of portions of the components or elements within a consistent but arbitrary frame of reference which is made clear by reference to the text and the associated drawings describing the components or elements under discussion. Moreover, terms such as “first,” “second,” “third,” and so on may be used to describe separate components. Such terminology may include the words specifically mentioned above, derivatives thereof, and words of similar import.

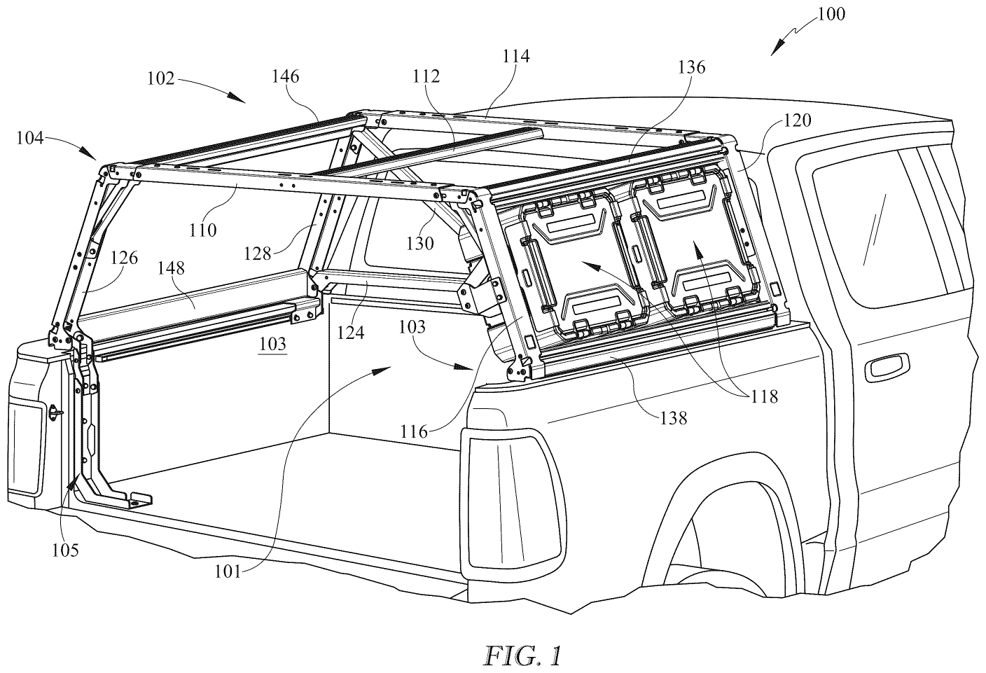

Referring now to FIGS. 1-11, embodiments of a rack system 102 for a truck bed 101 are provided. The rack system defines a framework and is formed of a plurality of supports which provide for various mounting configurations of one or more storage containers or accessories.

Referring now to FIG. 1, is a perspective view of a truck 100 with a rack system 102 mounted at the bed 101 of the truck 100. The rack system 102 may comprise a framework 104 with a plurality of supports and members, as well as one or more containers 118 and/or accessories which are retained on the framework 104. The rack system 102 is defined by a plurality of supports 116, 120, 126, 128 and members 110, 114, 122, 124, 130 which form the framework 104 adjacent to the truck bed 101. In the instant configuration depicted, but without limitation, the framework 104 is formed to extend upwardly from the sidewalls 103 of the bed 101 and provides storage that is disposed above the bed of the truck 100. The rack system 102 also comprises one or more storage containers 118 and/or accessories within the framework 104 wherein items may be stored or otherwise connected. In the depicted embodiment, two containers 118 are mounted to the framework 104.

The supports 116, 120, 126, 128 may have a length of from about 30 inches up to about 60 inches so that a space is created between the upper members 136, 146 and the upper edges of the truck bed sidewalls 103. This allows for positioning of the storage containers 118 there between. Additionally, the height of the uppermost members 136, 146 also allows for wide range of use of the bed 101 for many objects which may need to be hauled, as well as good access to the truck bed 101. In some configurations, the top of the framework 104 may be at or above the roof of the truck cabin.

The framework 104 may be connected to the truck bed in a variety of ways. For example, in some embodiments, the mounting brackets may be specific to vehicle makes and models. Further for example, truck beds may have factory mounting points and fixture locations. Some of these vehicle specific brackets are fitted directly to factory provided mounting locations within the bed or on the bed wall of the truck with supplied hardware. In some examples, the truck bed walls may comprise horizontal rails where the framework 104 may be connected. In some examples, a framework bracket 105 may be connected to the floor of the truck bed and/or the wall of the truck bed, as well as the framework. As shown in FIG. 1, a bracket or member 124 may connect to a rail in the truck bed near the forward end of the framework 104. A larger framework bracket 105 that connects to the bed 101 of the truck 100, may connect the rear end of the framework 104 to the truck bed. In some additional embodiments, a bracket may also be used along the front or forward end of the framework along the truck bed 101 at the cab of the truck, for example. Alternately, universal mounting brackets may be provided to use with multiple vehicle types to allow for connection the framework 104 to various truck makes and models.

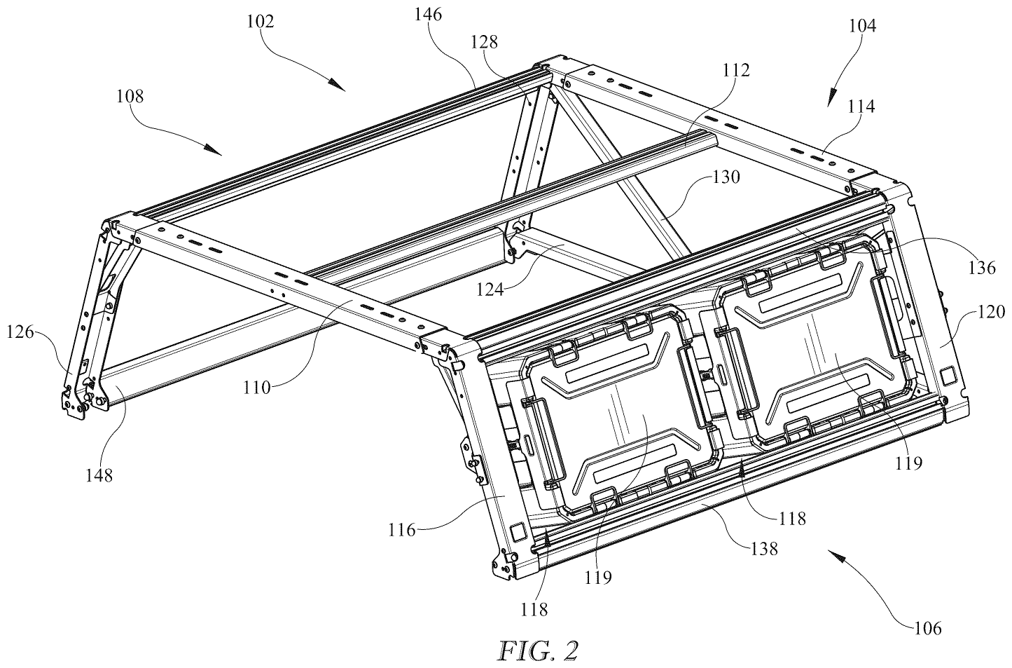

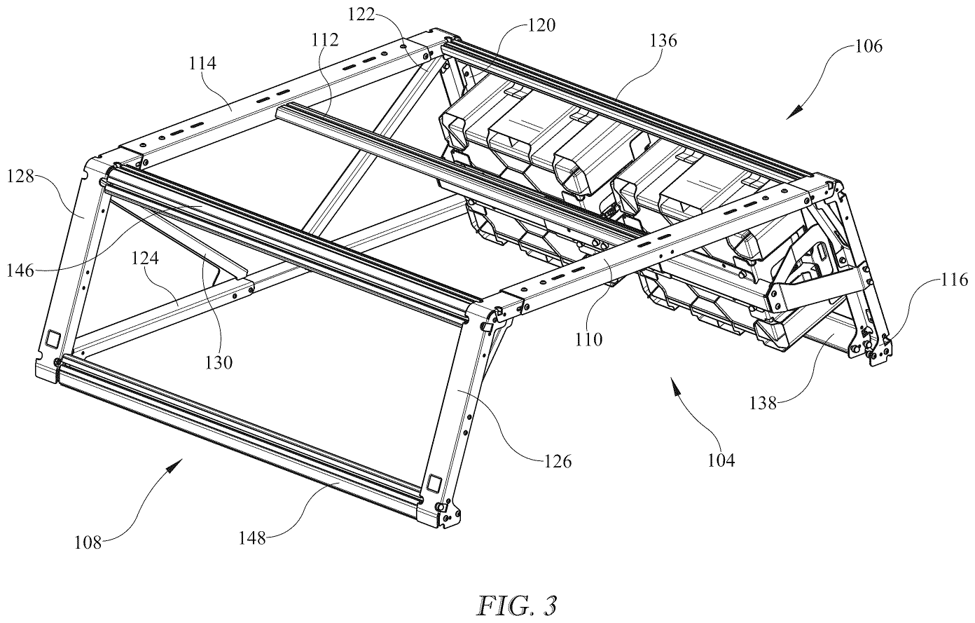

Referring now to FIGS. 2 and 3, perspective views the rack system 102 are shown removed from the truck bed 101. The framework 104 of supports and members is shown and described. The framework 104 is defined by a plurality of supports 116, 120, 126, 128 which are now described. The framework 104 may be formed of a first support 116 and a second support 120 along one or first side 106 of the truck bed 101. This may be, for example, along the long dimension of the truck bed 101. Also, disposed along the second side 108 of the truck bed 101 may be third and fourth supports 126, 128. The first side 106 and the second side 108 are generally spaced apart laterally and extend longitudinally. The members 136, 138, 146, 148 at these sides 106, 108 generally extend in the longitudinal (forward-rearward) direction of the vehicle. However, it should be understood this description is merely for understanding and should not be considered limiting.

For purpose of description, but without limitation, the first side 106 will be described as the side shown with the storage containers 118, and the second side 108 is shown and described as the side without the storage containers. Further for purpose of description, but without limitation, the forward end of the rack system 102 is shown with truss members 122, 130 (FIG. 3), while the rearward end of the rack system 102 is shown without any truss members. With the rearward end of the rack system 102 free of truss members, and also free of a lower laterally extending member, the truck bed 101 is more easily accessible by a user to load and unload materials, without needing to work around the truss members or a lower laterally extending member.

The first through fourth supports 116, 120, 126, 128 may be vertical members, substantially vertical, or may be angled relative to the vertical. The instant supports are shown as angled supports defining an angled plane between the first support 116 and the second support 120. Likewise, the second side, comprising the third support 126 and fourth support 128 may also be angled and defining a similar plane. In this way, the containers 118 may be mounted and stored on either or both the first side 106 and/or the second side 108 of the framework 104. Additionally, in some embodiments, it may be desirable to provide angled supports on one of the first or second sides 106, 108, and a vertical supports on the other of the first or second sides 106, 108. Thus, the planes of the two sides 106, 108 may be the same or may differ.

For purpose of orientation and clarity of description, but without limitation, the supports 120, 128 are located at the forward end of the framework 104 and the supports 116, 126 are located at the rearward end of the truck bed 101.

In these views, the framework 104 of the rack system 102 is shown. The framework 104 may comprise one or more longitudinal members 136, 138 that extend in the long direction of the rack system 102. The long or longitudinal direction may be defined as the long dimension of the truck bed 101, or alternately referred to as the forward-rearward direction in the orientation depicted. The framework 104 for example is shown with a first longitudinal member 136 and a second longitudinal member 138 extending between the first and second supports 116, 120. The first and second longitudinal members 136, 138 extend between from the upper and lower ends of the first support 116 and second supports 120. For purpose of description, but not to be limiting, the first and second longitudinal members 136, 138 are disposed on the first side 106 of the framework 104. Likewise, third and fourth longitudinal members 146, 148 extend between ends of the third support 126 and fourth support 128 on the second side 108. Further, the forward end of the framework 104 may comprise upper cross-members 114 and a lower cross-member 124. The upper and lower cross-members 114, 124 extend from corresponding upper and lower ends of the second and fourth supports 120, 128. The cross-members 114, 124 and the supports 120, 128 form a trapezoidal shape truss generally disposed in a vertical plane which may be positioned at a rearward end of the truck bed.

At the forward end of the framework 104, one or more truss members 122, 130 may also be located. For example as shown, there is a first truss member 122 and a second truss member 130. The first and second truss members 122, 130 may be connected at forward upper corners of the framework 104 and extend down to the lower cross member 124.

At the rearward end of the framework 104, the upper cross member 110 is shown extending between the supports 116, 126. Although not shown, the framework 104 may optionally include a lower cross member at the rearward end and one or more truss members at the rearward end. While this may hinder loading at the rear tailgate, the truss and lower cross members may increase loading capacity of the framework 104, if desired.

In the embodiment depicted, the framework 104 may also comprise an upper longitudinal member or joist 112 that extends between the first upper cross member 110 and the second upper cross member 114. The joist 112 may have various forms including but not limited to bar, beam, rail, or the like. This adds rigidity to the framework 104, as well as providing an optional location for hanging ropes, cords, or more generally a tie down location of anything being stored. In some configurations, the framework 104 may alternately comprise one or more lateral cross member positioned parallel to cross members 110, 114 that extends in a direction that is perpendicular to the longitudinal members 136, 146.

Any of the members, supports, and joist may include one structure or multiple structures. For example, as shown in FIGS. 2 and 3, the cross members 110, 114 may be hollow so that the ends may receive portions extending from the supports 116, 120, 126, 128. The cross members may be fastened to the portions extending from the supports.

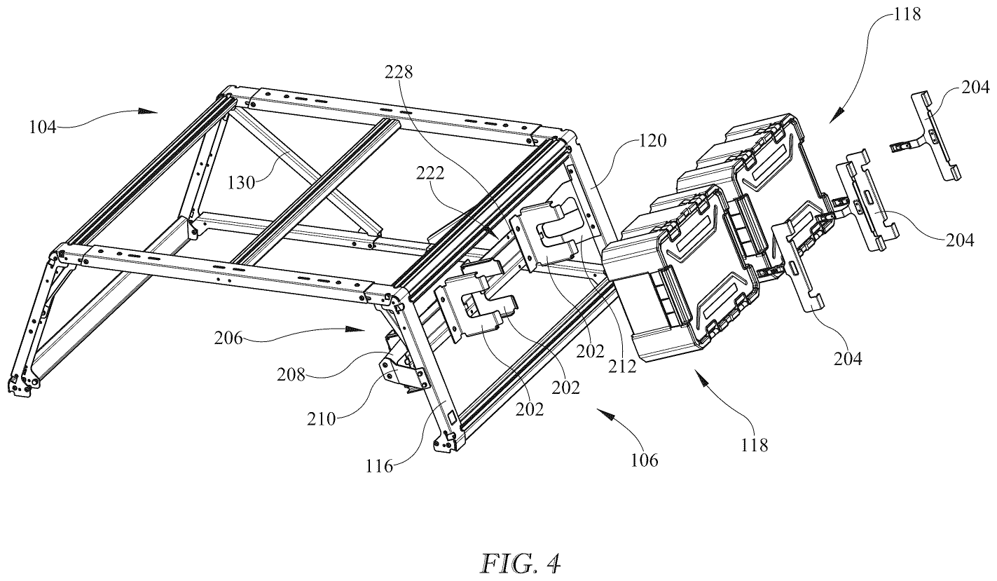

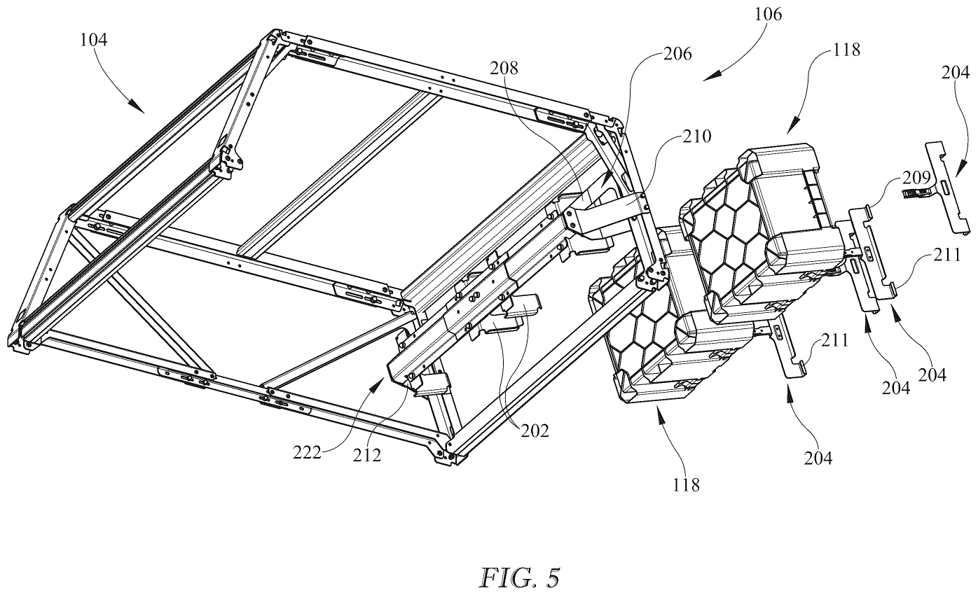

Referring now to FIGS. 4 and 5, perspective views of the framework 104 are provided wherein the storage containers 118 are exploded from the framework 104. With these views, the connections and support of the containers 118 are revealed for better explanation. Each of the first and second supports 116, 120 on the same lateral side, for example the first side 106 of the framework 104, further comprises a bar mount 206. The bar mounts 206 may be mounted on the inward side of the supports 116, 120 and opposite one another. The bar mounts 206 may each comprise a first leg 208 and a second leg 212 which both connect, directly or indirectly, to the first support 116 or the second support 120. The bar mounts 206 face one another and extend inwardly from the supports 116, 120 into the framework 104 toward the center of the truck bed 101. The inward extension creates a space between the plane of the supports 116, 120 and the inward ends of the bar mounts 206. In this space, the containers 118 may be positioned. One end of each leg 208, 212 is connected to each support 116, 120. The second end of each leg 208, 212 extending from a common support 116 or support 120 is joined to define a mounting location for an adjustable mounting bar 222, described further herein. The two legs 208, 212 and the supports 116 or 120 generally define a structural shape to provide structural stability and rigidity.

A stiffener 210 may be disposed on each the outward sides of the first and second supports 116, 120 and on the opposite side of each support from the bar mount 206. The stiffener 210 is located on one side 106 of the supports 116, 120 for example the outer side, and the bar mount 206 is located on a second, inner, side of the supports 116, 120. The bar mount 206 and the stiffener 210 may be joined by fastener and define a mounting location for the adjustable mounting bar 222.

The adjustable mounting bar 222 extends in the longitudinal direction between the first and second supports 116, 120. More specifically, the adjustable mounting bar 222 is positioned between the bar mounts 206 and stiffeners 210 that extend from the supports 116, 120. The adjustable mounting bar 222 forms a rear boundary for the storage containers 118. The adjustable mounting bar 222 may comprise slots, holes, or other features which allows adjustable movement of guide brackets 202. Each pair of guide brackets 202 defines a location for positioning of the container 118 therebetween. The guide brackets 202 may be adjustable to different positions along the adjustable mounting bar 222 and are spaced apart to receive the storage container therebetween. The guide brackets 202 may be spaced apart at different lengths to adjust for various sizes of containers or accessories as well as different positions along the adjustable mounting bar 222. In the non-limiting example, there are four guide brackets 202, two for each of the two depicted storage containers 118. One skilled in the art should recognize that one or more containers 118 may be used and therefore the number, spacing, and location of the guide brackets may vary.

In the depicted embodiment, there are four guide brackets 202 mounted to the adjustable mounting bar 222. The four guide brackets 202 are spaced apart such that each pair receives one container 118. Other numbers of guide brackets 202 may be used depending on the size and number of containers 118 being connected to the framework 104.

Additionally, the rack system 102 may comprise a plurality of container clamps 204. Each container clamp 204 may engage the adjustable mounting bar 222 or the guide brackets 202 at one end, and may comprise first and second fingers 209, 211 which engage an edge of the containers 118 at the second end. The container clamp 204 may engage the upper or outer edge of the container 118 or the container lid 119 defining a forward limitation of movement. Thus, the adjustable mounting bar 222 defines a rear limitation of movement and the container clamp 204 defines a forward limitation, between which the containers 118 are captured.

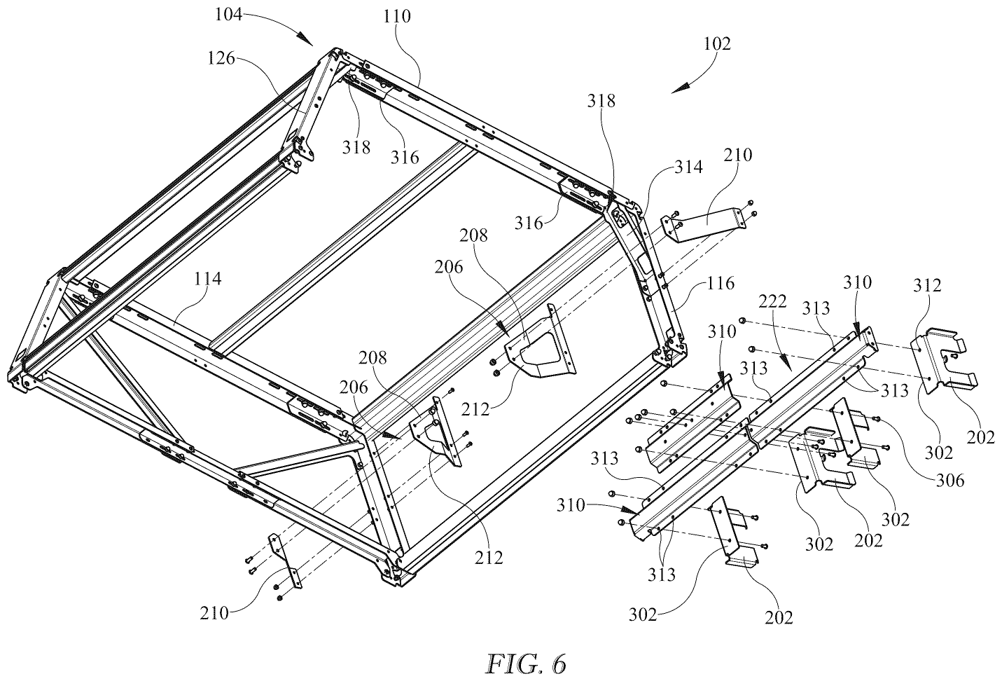

Referring now to FIG. 6 a partially exploded perspective view of the rack system 102 is shown. The adjustable mounting bar 222 is exploded from the framework 104 and the bar mounts 206. The adjustable mounting bar 222 is shown in perspective view and, in some embodiments, may in the shape of a bar, beam, member, rail, or the like. In some embodiments, the adjustable mounting bar 222 may be formed of two or more fabricated plates 310 that may be fastened together to define the adjustable mounting bar 222. The fabricated plates 310 may comprise two or more bends to provide rigidity to the adjustable mounting bar 222. The plates 310 may have multiple holes or slots to adjust the length of the adjustable mounting bar 222 or to change positions of holes for mounting the guide brackets 202. The adjustability of the length of the adjustable mounting bar 222 allows for use with truck bed of different lengths. The instant configuration is shown, for example but without limitation, with three plates 310 that extend between the first and second supports 116, 120.

In some other configurations, the adjustable mounting bar 222 may comprise a rectangular cross-sectional shape, but may be alternate shapes as well. With the rectangular shape, there is an outwardly directed presenting face 228 (FIG. 4) of the adjustable mounting bar 222 that engages or contacts the container guide 202. The container guide 202 may be fastened or otherwise connected to the adjustable mounting bar 222 along the presenting face 228. The adjustable mounting bar 222 may have one or more slots or holes 313 that extend in the longitudinal direction of the adjustable mounting bar 222. The slots or holes 313 allow for various positions to mount the guide brackets 202 along the length of the adjustable mounting bar 222.

The guide brackets 202 may comprise a flange 302 which has fastener holes 312. One or more fasteners 306 may extend through the flange 302 of the guide brackets 202 and into the adjustable mounting bar 222. By loosening such fasteners, the guide brackets 202 may be moved relative to the adjustable mounting bar 222.

Referring still to FIG. 6, the containers 118 are removed and the attachment components to retain the containers are exploded. From the lower perspective view, adjustability of the cross members 110, 114 is depicted. The cross members 110, 114 may be adjustable in the lateral or width direction in order to accommodate truck beds of differing widths. The cross members 110, 114 may be adjustable to expand or contract relative to supports 116, 120, 126 128. An angled adjustment slat 318 is shown extending between the supports 116, 126, 120, 128 and the cross members 110, 114. The angled adjustment slat 318 may have a first slat portion 314 which engages the support 116 and a second slat portion 316 which adjustably engages the cross member 110. For example, the second portion 316 may comprise a slot to cooperate with a fastener hole in the cross member 110 to allow the lateral or width adjustment to the rearward end of the framework 104. Alternately, the cross member 110 may comprise a slot while the second portion 316 may comprise the fastener hole.

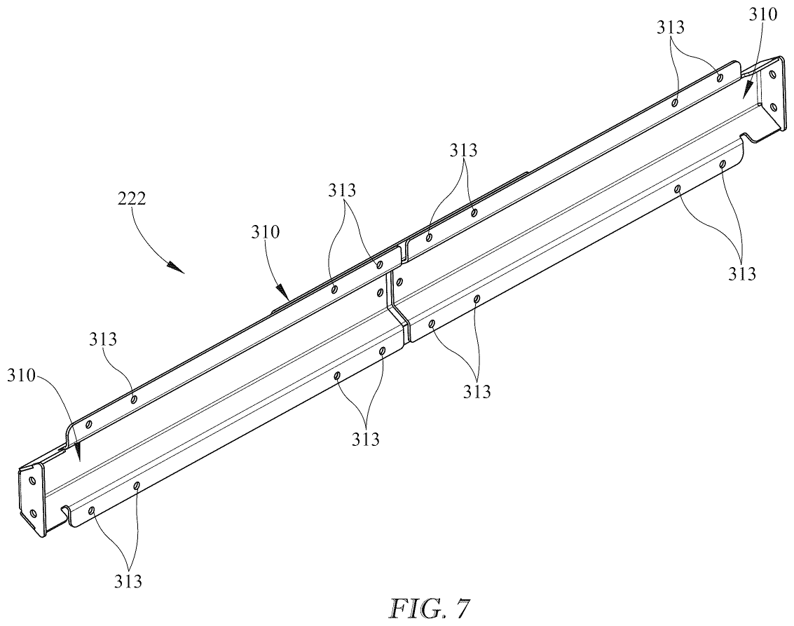

Referring now to FIG. 7, a perspective view of the adjustable mounting bar 222 is shown. The adjustable mounting bar 222 may be formed of the one or more plates 310. In the instant embodiment, the adjustable mounting bar 222 is formed, without limitation, of three plates. The number and length of each plate 310 may vary. Each of the plates 310 is may be fabricated, for example by press, machined, forged, extrusion, or other manufacturing technique, and formed with a generally U-shaped cross-section. Further, the ends of the adjustable mounting bar 222 may define a location for connection to the bar mounts 206. The multiple plates 310 may be aligned so that they may be joined by fasteners or other joinder devices. In some configurations, the plates 310 may also be slidably adjusted to fit frameworks of various lengths between supports. Thus the plates 310 of the adjustable mounting bar 222 allow for use with truck beds of various sizes. Additionally, the guide brackets 202 may be adjustably located along the adjustable mounting bar 222 by varying positioning of holes along the adjustable mounting bar 222, or by utilizing slots extending along the adjustable mounting bar 222.

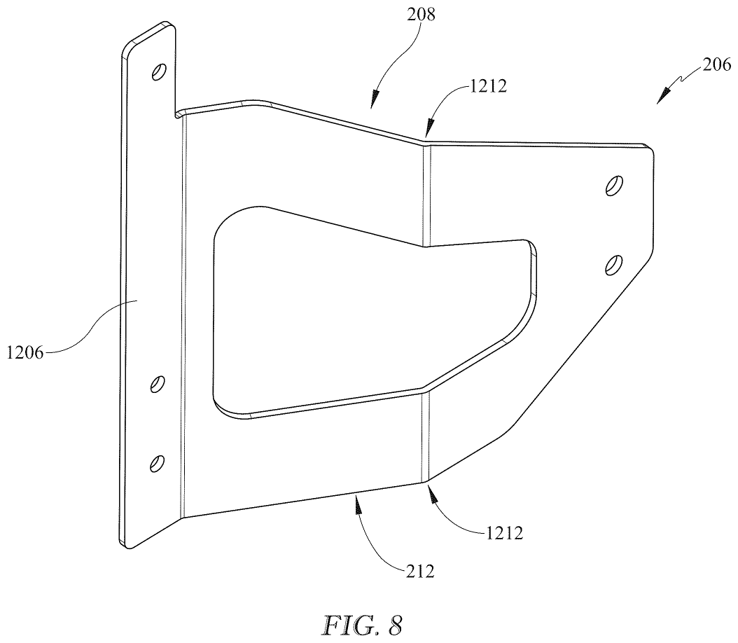

Referring now to FIG. 8, a perspective view of the bar mount 206 is shown for brief description. The bar mount 206 comprises a plate 1206 which is configured to engage the opposed supports 116, 120. One bar mount 206 is mounted to each support 116, 120 and extends into the bed footprint of the truck bed 101. A first bracket leg 208 and a second bracket leg 212 each extend from the bracket mounting plate 1206. The legs 208, 212 may have elbows 1212 so that the ends of the legs 208, 212 opposite the bracket mounting plate 1206 are spaced apart a preselected distance when mounted. The elbows 1212 also provide additional rigidity for the bar mount 206. The preselected distance is sized to receive the adjustable mounting bar 222. The adjustable mounting bar 222 may therefore be sized to fit between ends of the two opposed brackets 202.

Further as previously referenced, each support 116, 120 comprises one bar mount 206. Each bar mount 206 is on an opposing surface of the supports 116, 120 so that the two brackets 202 both are facing one another. On an opposite side of each support 116, 120 from the bar mount 206, the stiffener 210 is positioned to engage the bar mount 206 and the adjustable mounting bar 222 and provide additional rigidity in the longitudinal direction of the framework, that is between the supports 116, 120.

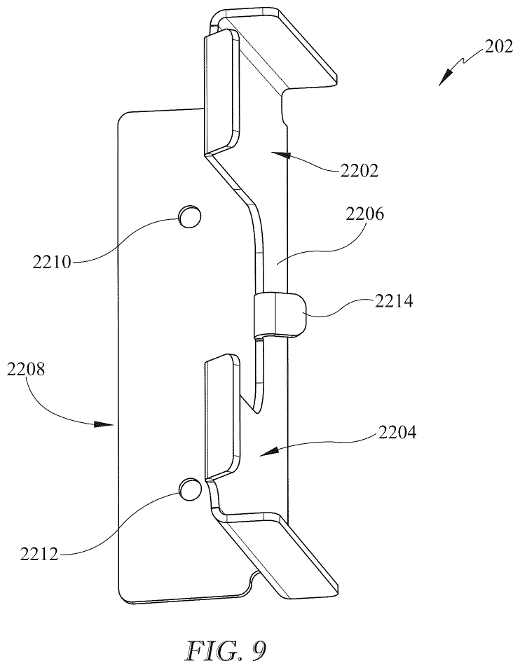

Referring now to FIG. 9, a perspective view of the container guide 202 is shown. The container guide 202 comprises a U-shaped structure which is connected to the adjustable mounting bar 222. The U-shaped structure comprises two parallel arms 2202, 2204 and a joining portion 2206 extending between the two arms. The two arms 2202, 2204 extend from the joining portion 2206, and extend away from the adjustable mounting bar 222.

The container guide 202 may further comprise a flange 2208 that extends from the adjustable mounting bar 222. The flange 2208 may provide a structure or aperture for connection of the container guide 202 to the adjustable mounting bar 222. For example, but without limitation, the flange 2208 may include first and second mounting apertures 2210, 2212 which are spaced apart. The apertures 2210, 2212 allow for fasteners to connect the flange 2208 to the adjustable mounting bar 222. The spacing and positioning of the apertures 2210, 2212 limit rotation of the container guide 202 relative to the adjustable mounting bar 222.

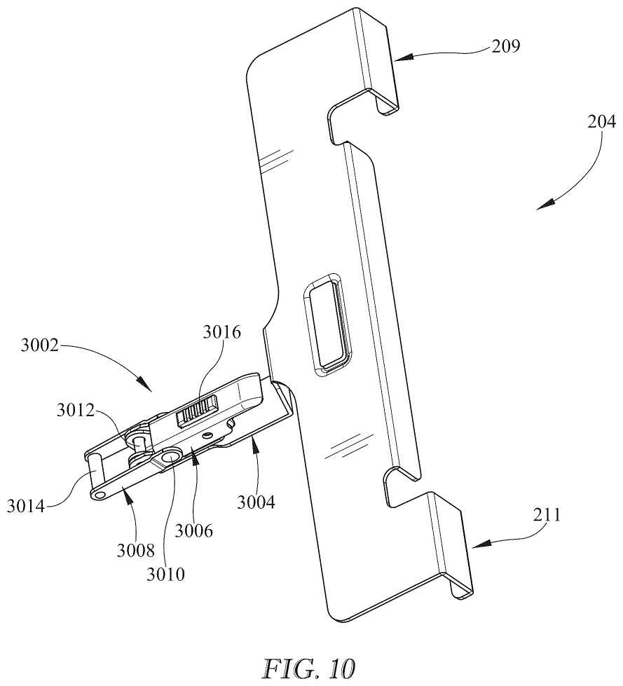

Also extending from the joining portion 2206 between the arms 2202, 2204 is a catch 2214. The catch 2214 extends outwardly and provides a location for engagement with the container clamps 204 (FIG. 10).

Referring now to FIG. 10, the container clamp 204 is shown in perspective view. The clamp 204 provides a first finger 209 and a second finger 211 which extend outwardly and engage the container lid 119. The clamp 204 is generally T-shaped and has a latch 3002 on the single leg 3004 of the clamp 204. In some embodiments, the latch 3002 may be an over center latch, for non-limiting example. The latch 3002 comprises a first latch portion 3006 and a second latch portion 3008 which are pivotally connected to one another. In the example, the latch 3002 comprises two pivots, pivot 3010 and pivot 3012 to define the over center configuration. The first latch portion 3006 is pivotable to move a pin 3014 of the second latch portion 3008 laterally into and out of engagement with the catch 2214 (FIG. 9). The pin 3014 of the second latch portion 3008 is capable of engaging the catch 2214 of the container guide 202 (FIG. 9) and the first latch portion 3006 moves to tighten against the catch 2214 (FIG. 9). In this way, when the clamp 204 is positioned to engage the container lid 119 (FIG. 2), the clamp fingers 209, 211 pull on the lid 119 toward the catch 2214 so that the container 118 and lid 119 are retained in position. The first latch portion 3006 may also have a safety catch 3016 which has to be disengaged over the latch, thus providing a safety feature to prevent unanticipated disengagement.

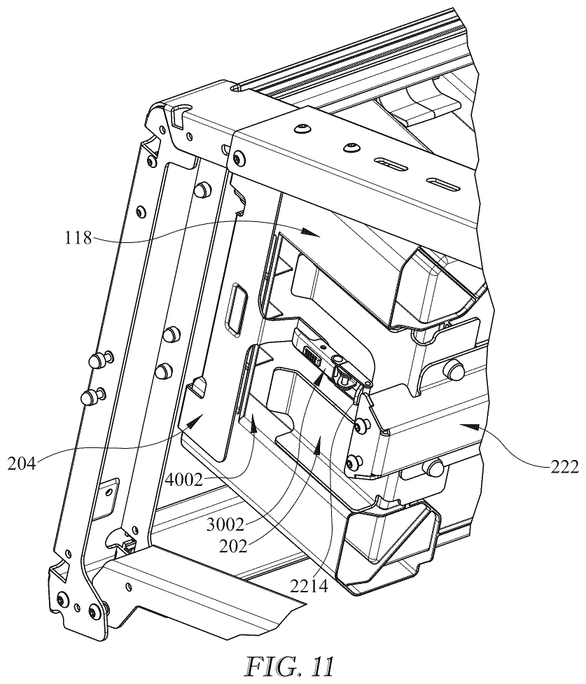

Referring now to FIG. 11, a perspective view depicting the interaction between the guide bracket, the clamps 204, and the container 118 is depicted. As previously described, the adjustable mounting bar 222 extends between bar mounts 206. The bar mounts 206 support the adjustable mounting bar 222. The guide brackets 202 extend from the adjustable mounting bar 222 and each pair of guide brackets 202 is spaced apart to receive one of the storage containers 118.

Each container 118 comprises a recessed hand grip area 4002 on opposed sides of the container 118. The recess 4002 provides a position for the U-shaped structure of the container guide 202. More specifically, the outermost ends of the container guide 202 may be inserted into the recess 4002. This positions the storage container 118 appropriately relative to the container guide 202 on two sides of the container 118. Once this occurs, the container 118 is retained in the inward direction of the truck bed by the flange 2208 of the container guide 202 and the adjustable mounting bar 222. The container 118 is also retained in the longitudinal direction of the truck bed by the two guide brackets 202. At this point the container 118 still has a degree of freedom in the outward direction of the truck bed.

The container clamp 204 is then applied to the container 118 to retain the container lid 119 in position, as well as limit movement outward relative to the truck bed 101. The fingers 209, 211 of the clamp 204 curl over the edge of the container lid 119. At the opposite end of the clamp 204, the latch 3002 engages the catch 2214 of the container guide 202. The latch 3002 may be pivoted to lock the clamp 204 relative to the container guide 202. This locks the storage container 118 relative to the outward direction of the truck bed 101.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the invent of embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms. The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases.

Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Unless otherwise indicated, all numbers expressing quantities of ingredients, properties such as reaction conditions, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount of mass, weight, time, volume, concentration or percentage is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed method.

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

Certain terminology is used in the following description for convenience only and is not limiting. The words “right,” “left,” “top,” and “bottom” designate directions in the drawings to which reference is made. The words “a” and “one” are defined as including one or more of the referenced item unless specifically stated otherwise. This terminology includes the words above specifically mentioned, derivatives thereof, and words of similar import. The phrase “at least one” followed by a list of two or more items, such as A, B, or C, means any individual one of A, B, or C as well as any combination thereof.

The foregoing description of methods and embodiments has been presented for purposes of illustration. It is not intended to be exhaustive or to limit the invention to the precise steps and/or forms disclosed, and obviously many modifications and variations are possible in light of the above teaching. It is intended that the scope of the invention and all equivalents be defined by the claims appended hereto.

1. A truck bed rack system, comprising:
a first support configured to be mounted along one side of a truck bed;
a second support configured to be mounted along said one side of the truck bed and spaced from said first support;
a third support configured to be mounted along a second side of said truck bed;
a fourth support configured to be mounted along said second side of said truck bed;
a first cross-member extending between said first support and said third support;
a second cross-member extending between said second support and said fourth support;
a first bar mount extending from one of said supports;
a second bar mount extending from a second of said supports;
an adjustable mounting bar extending between said first bar mount and said second bar mount;
a first container guide connected to said adjustable mounting bar and a second container guide connected to said adjustable mounting bar, said second container guide spaced from said first container guide and configured to receive a storage container, said first container guide and said second container guide defining a width limit for said storage container;
said adjustable mounting bar defining a rear positioning limit for said storage container.

2. The truck bed rack system of claim 1, further comprising a first stiffener extending between said first support and said first bar mount.

3. The truck bed rack system of claim 2, further comprising a second stiffener extending between said second support and said second bar mount.

4. The truck bed rack system of claim 3, each of said first bar mount and said second bar mount being generally triangular in shape.

5. The truck bed rack system of claim 3, said first stiffener being disposed on one side of said first support and said first bar mount disposed on an opposite side of said first support.

6. The truck bed rack system of claim 5, said first stiffener and said first bar mount connected at ends spaced from said first support.

7. The truck bed rack system of claim 5, said second stiffener being disposed on one side of said second support and said second bar mount disposed on an opposite side of said second support.

8. The truck bed rack system of claim 7, said second stiffener and said second bar mount connected at ends spaced from said second support.

9. The truck bed rack system of claim 1, further comprising a first storage clamp and a second storage clamp retaining said storage container.

10. The truck bed rack system of claim 9, said first storage clamp and said second storage clamp attached to said first container guide and said second container guide, respectively.

11. The truck bed rack system of claim 9, said first storage clamp and said second storage clamp connected to said storage container and said first container guide and said second container guide.

12. The truck bed rack system of claim 1, said first support and said second support being angled relative to a vertical reference.

13. The truck bed rack system of claim 1, said storage container being mounted in an angled configuration so that a lid of said storage container is either aligned or is parallel with a plane extending between said first and second supports.

14. The truck bed rack system of claim 1, further comprising one or more holes or grooves positioned axially along said adjustable mounting bar and configured to receive fasteners.

15. The truck bed rack system of claim 14, further comprising one or more fastening locations at ends of said adjustable mounting bar.

16. The truck bed rack system of claim 1, further wherein the truck bed rack system is secured either to factory fixing points in the truck bed or factory rails of the truck bed.
